(19) United States
(12) Patent Application Publication
(10) Pub. No.: US 2020/0134568 A1
(43) Pub. Date: Apr. 30, 2020

(54) COGNITIVE ASSESSMENT RECOMMENDATION AND EVALUATION

(71) Applicant: INTERNATIONAL BUSINESS MACHINES CORPORATION, ARMONK, NY (US)

(72) Inventors: Venkata Vara Prasad Karri, Visakhapatnam (IN); Sushil B. Ravi, Visakhapatnam (IN); Jagadeesh Pataballa, Visakhapatnam (IN); Sri Harsha Varada, Vizianagaram (IN); Sailaja S. Perumalla, Visakhapatnam (IN)

(21) Appl. No.: 16/172,074

(22) Filed: Oct. 26, 2018

(51) Int. Cl. G06Q 10/10; G06F 17/27

(52) U.S. Cl. CPC G06Q 10/1053; G06F 17/27

(57) ABSTRACT

A method, computer system, and computer program product for cognitive assessment recommendation and evaluation are provided. The embodiment may include receiving a candidate's resume and a job description from a database. The embodiment may also include generating interview questions based on common keywords or key phrases found in the resume and the job description. The embodiment may further include identifying critical points to be verified based on analysis of candidate responses to the generated interview questions. The embodiment may also include validating the critical points against data obtained from public records, official documentation, and documents submitted by the candidate. The embodiment may further include creating referenceable content which includes the identified critical points and a summary of the data used to validate the critical points.

### BACKGROUND

The present invention relates, generally, to the field of computing, and more particularly to a pre-employment assessment.

Pre-employment assessment is a tool or method to guide a hiring organization to assess a candidate's qualification for a position. A pre-employment assessment may include anything from an interview to a background check to a personality assessment. Employees are one of the most valuable assets of an organization, and hiring new employees is a risky task as hiring mistakes can be very costly. Objective data related to job candidates' aptitude, personality, and professional skills may provide a hiring organization with objective data to facilitate and inform the organization's evaluations and decisions. Effective pre-employment assessment tools can help an organization reduce time-to-hire and turnover and increase overall productivity.

### SUMMARY

According to one embodiment, a method, computer system, and computer program product for cognitive assessment recommendation and evaluation are provided. The embodiment may include receiving a candidate's resume and a job description from a database. The embodiment may also include generating interview questions based on common keywords or key phrases found in the resume and the job description. The embodiment may further include identifying critical points to be verified based on analysis of candidate responses to the generated interview questions. The embodiment may also include validating the critical points against data obtained from public records, official documentation, and documents submitted by the candidate. The embodiment may further include creating referenceable content which includes the identified critical points and a summary of the data used to validate the critical points.

### BRIEF DESCRIPTION OF THE SEVERAL VIEWS OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a cognitive assessment recommendation and evaluation process according to at least one embodiment;

FIG. 3 is a functional block diagram of a cognitive assessment recommendation and evaluation platform according to at least one embodiment;

FIG. 4 is a block diagram of internal and external components of computers and servers depicted in FIG. 1 according to at least one embodiment;

FIG. 5 depicts a cloud computing environment according to an embodiment of the present invention; and

FIG. 6 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to cognitive assessment recommendation and evaluation systems. The following described exemplary embodiments provide a system, method, and program product to, among other things, allow a user to analyze job candidates' responses to interview questions and identify critical points to be verified or validated. Therefore, the present embodiment has the capacity to improve the technical field of pre-employment assessment systems by comparing and transmuting previously-used interview questions into new interview questions in various versions based on the analysis of a candidate's resume, previous responses to similar interview questions and job descriptions. Moreover, the present embodiment has the capacity to generate assessment scores for each candidate so that hiring organizations can make decisions based on objective data.

As previously described, pre-employment assessment is a tool or method to guide a hiring organization to assess a candidate's qualification for a position. A pre-employment assessment may include anything from an interview to a background check to a personality assessment. Employees are one of the most valuable assets of an organization, and hiring new employees is a risky task as hiring mistakes can be very costly. Objective data related to job candidates' aptitude, personality, and professional skills may provide a hiring organization with objective data to facilitate and inform the organization's evaluations and decisions. Effective pre-employment assessment tools can help an organization reduce time-to-hire and turnover and increase overall productivity.

The effectiveness of an assessment system lies in its content. Typically, most hiring organizations tend to utilize the previously utilized assessment content from the previous hiring processes. For example, most recruiters tend to ask candidates the same or similar questions during an initial interview or they refer to the same references from the past, such as previously submitted resumes or cover letters. Only a few recruiters or hiring personnel make additions to keep the basic assessment content up to date. As such, it may be advantageous to, among other things, implement a system capable of creating a content engine that can provide the most relevant and up-to-date questions as to various skills, competencies, aptitude, or expertise by transmuting a plurality of previously used interview questions into a set of new questions that are more relevant to a current hiring situation.

According to one embodiment, a cognitive assessment recommendation and evaluation program may update assessment systems by evaluating the resumes of candidates, job descriptions, and the existing interview questions that are currently used. A cognitive assessment recommendation and evaluation program may also auto validate candidates' responses by generating different versions of the same interview questions to flag the candidate credibility. In at least one other embodiment, a cognitive assessment recommendation and evaluation program may evaluate and compare scores and evaluation parameters when different recruiters utilize the same interview questions for different candidates to ascertain the accuracy of the assessment scores and the evaluation parameters.

The present invention may be a system, a method, and/or a computer program product at any possible technical detail level of integration. The computer program product may include the computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or another device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product for cognitively assessing recommendation and candidates evaluations during a pre-employment assessment stage.

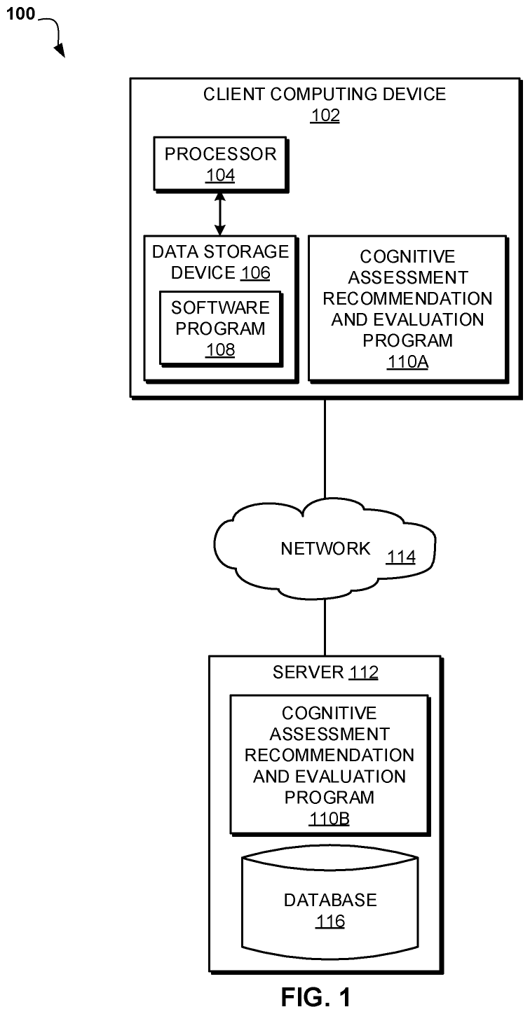

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112 of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

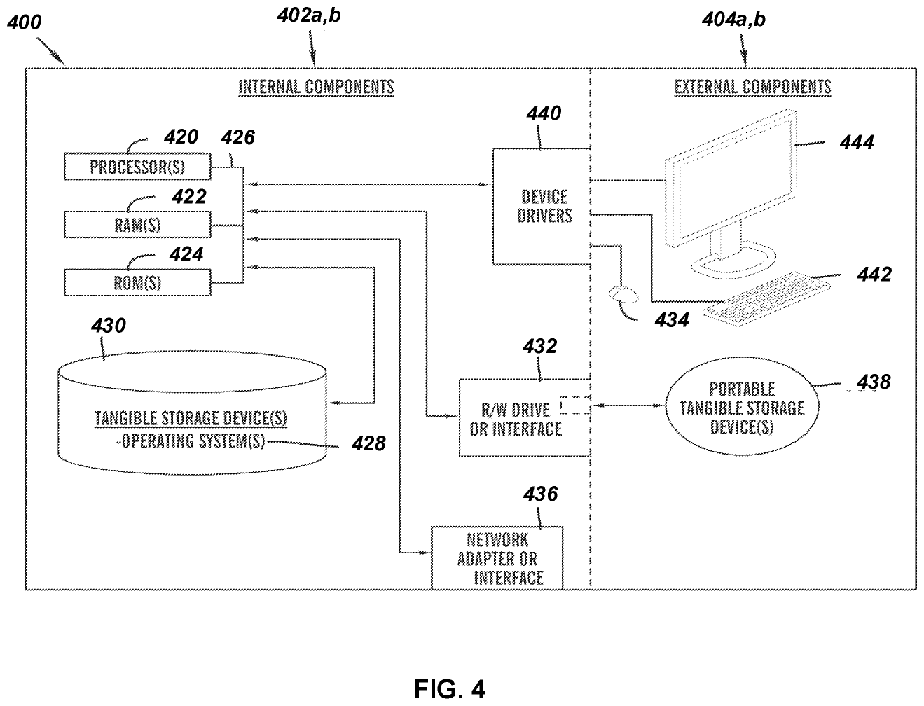

Client computing device 102 may include a processor 104 and a data storage device 106 that is enabled to host and run a software program 108 and a cognitive assessment recommendation and evaluation program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 4, the client computing device 102 may include internal components 402a and external components 404a, respectively.

The server computer 112 may be a laptop computer, netbook computer, personal computer (PC), a desktop computer, or any programmable electronic device or any network of programmable electronic devices capable of hosting and running a cognitive assessment recommendation and evaluation program 110B and a database 116 and communicating with the client computing device 102 via the communication network 114, in accordance with embodiments of the invention. As will be discussed with reference to FIG. 4, the server computer 112 may include internal components 402b and external components 404b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

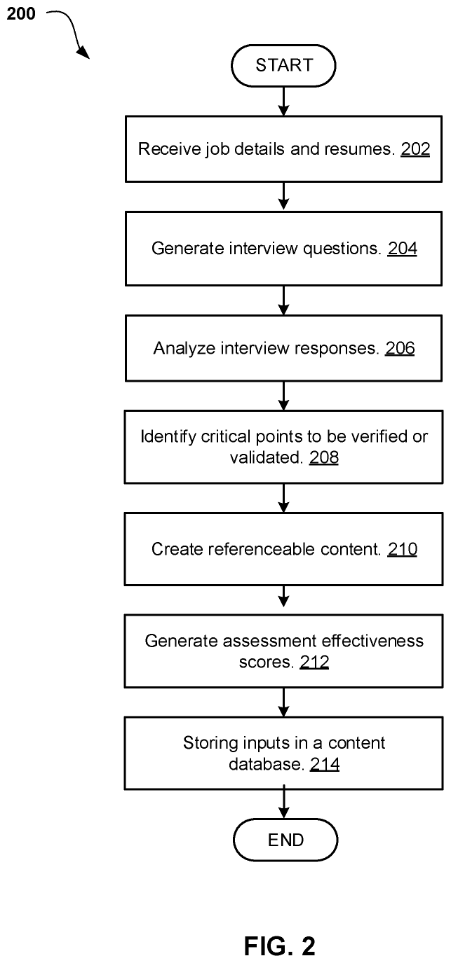

According to the present embodiment, the cognitive assessment recommendation and evaluation program 110A, 110B may be a program capable of analyzing the current interview questions and responses and recommending assessment scores for further interviews. The cognitive assessment recommendation and evaluation program 110A, 110B may also continuously update a plurality of databases with a plurality of assessment data collected analyzing interview responses in conjunction with relevant job descriptions and skills and experiences listed on a resume. The cognitive assessment recommendation and evaluation process is explained in further detail below with respect to FIG. 2.

FIG. 2 is an operational flowchart illustrating a cognitive assessment recommendation and evaluation process 200 according to at least one embodiment. At 202, the cognitive assessment recommendation and evaluation program 110A, 110B receives job details and resumes. For example, the cognitive assessment recommendation and evaluation program 110A, 110B may receive job details and job candidates' resumes from a plurality of databases when recruiters or hiring companies post job positions online and candidates submit their resumes. In at least one other embodiment, the cognitive assessment recommendation and evaluation program 110A, 110B may group particular jobs and applicants into specific categories, such as legal positions, accounting positions, corporate executives, finance, and banking, etc.

At 204, the cognitive assessment recommendation and evaluation program 110A, 110B generates interview questions. According to one embodiment, the cognitive assessment recommendation and evaluation program 110A, 110B may analyze the posted job details and the received resumes to generate interview questions based on a candidate's prior experiences, education, relevant skills, and related accomplishments, utilizing known natural language processing techniques. The cognitive assessment recommendation and evaluation program 110A, 110B may also collect interview questions that have already been used during previous hiring processes for the same or similar job positions. The cognitive assessment recommendation and evaluation program 110A, 110 may further analyze currently prepared interview questions to assess how well a resume matches the required qualifications described in the job details, utilizing token analysis techniques. The cognitive assessment recommendation and evaluation program 110A, 110B may also generate a form or written questionnaires for candidates based on common keywords or key phrases found in both the resumes and the job details. The cognitive assessment recommendation and evaluation program 110A, 110B may further generate interview questions based on candidates' previous answers to interview questions or written questionnaires in the past in connection with the same or similar job positions. For example, if a candidate had a telephonic interview with a recruiter three months ago and now wants to apply to a similar job posted by another recruiter, the cognitive assessment recommendation and evaluation program 110A, 110B may analyze the changes in the same candidate's skills and experiences and the differences in the new job position, and generate a default form with the questions asked by the first recruiter along with the previous responses given by the candidate. The cognitive assessment recommendation and evaluation program 110A, 110B may then create a second version of the form with the questions to be asked by the second recruiter.

At 206, the cognitive assessment recommendation and evaluation program 110A, 110B analyzes interview responses. According to one embodiment, the cognitive assessment recommendation and evaluation program 110A, 110B may analyze candidates' responses to the generated interview questions and generate a written report of the conversations. The cognitive assessment recommendation and evaluation program 110A, 110B may further analyze candidates' written responses to the questionnaires submitted prior to an in-person interview. For example, candidates are sometimes asked to submit answers to certain basic questionnaires before an interview, which consists of questions as to education, relevant experiences, willingness to relocate, etc. According to another embodiment, the cognitive assessment recommendation and evaluation program 110A, 110B may identify the responses given by a candidate for the same or similar interview questions in the past if the candidate is seeking to be re-hired and the recruiters want to gauge any improvement on the candidate's skills or qualifications. Any progress or learning the candidate may have made or achieved may be analyzed and displayed in a report that the cognitive assessment recommendation and evaluation program 110A, 110B may generate.

At 208, the cognitive assessment recommendation and evaluation program 110A, 110B identifies a critical point to be verified or validated. Critical points may relate to discrepancies in previously-submitted written responses and recent conversations that the cognitive assessment recommendation and evaluation program 110A, 110B may identify or may be designated by users. According to one embodiment, the cognitive assessment recommendation and evaluation program 110A, 110B may highlight key findings of conversations or written responses to a pre-interview questionnaire that need to be verified or validated against evidence. The cognitive assessment recommendation and evaluation program 110A, 110B may utilize known voice capturing systems to record and analyze conversations between recruiters and candidates. For example, the cognitive assessment recommendation and evaluation program 110A, 110B may determine that the year of graduation of college stated in a candidate's resume does not match what the candidate mentioned during an in-person interview and generate a report highlighting that the year of graduation needs to be further verified. In one other embodiment, the cognitive assessment recommendation and evaluation program 110A, 110B may also highlight the contradicting qualifications or skills found in the previous resume or interview responses in comparison with the current resume or interview responses.

At 210, the cognitive assessment recommendation and evaluation program 110A, 110B creates referenceable content. According to one embodiment, the cognitive assessment recommendation and evaluation program 110A, 110B may create referenceable content by collecting a report or a summary of previously used interview questions, candidates' responses, candidates' skills and experiences, and the list of information that has already been verified or needs to be further verified. For example, when a candidate's duration of previous employment is doubtful, an interviewer or a recruiter might have left a note stating that certain information such as duration of the candidate's previous employment needs to be verified by directly contacting the previous employer. The cognitive assessment recommendation and evaluation program 110A, 110B may have added such information or a note to an already-generated summary or report as a reminder. According to another embodiment, the cognitive assessment recommendation and evaluation program 110A, 110B may create referenceable content by generating a set of questions recommendable to other recruiters for future use when hiring needs for a similar position arise and the same or similar qualifications are sought. According to one other embodiment, the cognitive assessment recommendation and evaluation program 110A, 110B may interact with a plurality of systems and databases simultaneously or almost simultaneously to receive a continuous feed of changes in skills, technology, competencies and new trends that may help in determining any differences in the existing interview questions or the referenceable content and providing suggestions for the next hiring process. The content database may also receive the same types of inputs from, including but not limited to, exemplary solutions from the current project, employee skill sets, experiences, certifications and capabilities, universities, whitepapers, science journals, and IEEE papers.

At 212, the cognitive assessment recommendation and evaluation program 110A, 110B generates assessment effectiveness scores. According to one embodiment, the cognitive assessment recommendation and evaluation program 110A, 110B may analyze the content of resumes, job description and the candidate's responses to interview questions. Once the analysis is complete, the cognitive assessment recommendation and evaluation program 110A, 110B may determine an evaluation score or rating for each candidate's qualification based on analysis of how well the qualifications stated in resumes match job descriptions utilizing a pre-configured algorithm. For example, if a candidate's resume and the candidate's responses to an interviewer's questions are determined to be a good fit for a job position compared to other candidates, the candidate receives a score of 10 on a scale of 1 to 10. The cognitive assessment recommendation and evaluation program 110A, 110B may further generate checklists to ensure that all necessary questions are asked during an interview to fairly evaluate a candidate. For example, a measure of hits and misses of assessment via checkmarks of what aspects of a resume has been evaluated and what has not been.

At 214, the cognitive assessment recommendation and evaluation program 110A, 110B stores inputs in a content database. According to one embodiment, the cognitive assessment recommendation and evaluation program 110A, 110B may save or update a candidate's assessment report, references and other referenceable content from previous interactions in one or more databases. In at least one other embodiment, the cognitive assessment recommendation and evaluation program 110A, 110B may select previously used interview questions from a content database and suggest a different version of the same question when a recruiter interviews a different candidate for a similar position.

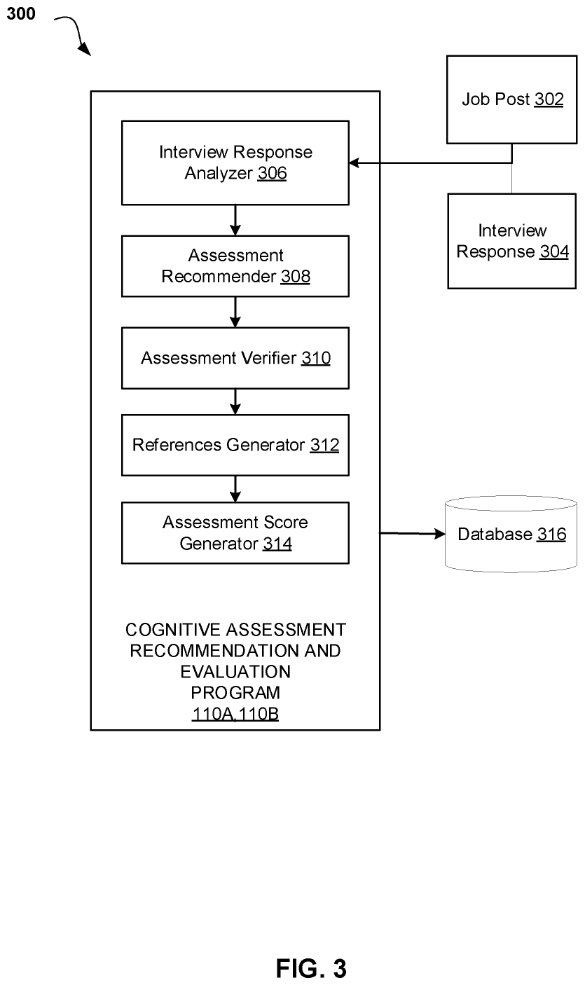

Referring now to FIG. 3, a functional block diagram of a cognitive assessment recommendation and evaluation process 300 is depicted according to at least one embodiment. According to one embodiment, the cognitive assessment recommendation and evaluation program 110A, 110B may consist of an interview response analyzer 306, an assessment recommender 308, an assessment verifier 310, a references generator 312 and an assessment score generator 314. The cognitive assessment recommendation and evaluation program 110A, 110B may receive job details from job posts 302 and candidates interview responses 304. The interview response analyzer 306 may analyze interview questions and candidates' responses. The assessment recommender 308 may then determine whether the interviewed candidates need to be re-assessed by conducting an additional interview or requiring the candidates to submit written forms. The assessment verifier 310 may verify uncertain information that has been discovered during an interview process in comparison to what a candidate has submitted (e.g. resume, cover letter or written responses to questionnaires, etc.) The references generator 312 may collect all the verified information and the information that has been obtained during the interview or other related processes in a form of written report for future references. The assessment score generator 314 may determine an evaluation score or rating for each candidate. The cognitive assessment recommendation and evaluation program 110A, 110B may then save the generated references and the assessment scores in a plurality of databases 316.

It may be appreciated that FIGS. 2-3 provide only an illustration of one implementation and do not imply any limitations with regard to how different embodiments may be implemented. Many modifications to the depicted environments may be made based on design and implementation requirements. For example, in at least one embodiment, the cognitive assessment recommendation and evaluation program 110A, 110B may evaluate and compare scores and evaluation parameters when different recruiters use the same assessment or interview questions for different or similar candidates to ascertain the commonality of interview questions or responses provided by candidates.

FIG. 4 is a block diagram 400 of internal and external components of the client computing device 102 and the server 112 depicted in FIG. 1 in accordance with an embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

The data processing system 402, 404 is representative of any electronic device capable of executing machine-readable program instructions. The data processing system 402, 404 may be representative of a smart phone, a computer system, PDA, or other electronic devices. Examples of computing systems, environments, and/or configurations that may represented by the data processing system 402, 404 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 402 a,b and external components 404 a,b illustrated in FIG. 4. Each of the sets of internal components 402 include one or more processors 420, one or more computer-readable RAMs 422, and one or more computer-readable ROMs 424 on one or more buses 426, and one or more operating systems 428 and one or more computer-readable tangible storage devices 430. The one or more operating systems 428, the software program 108 and the cognitive assessment recommendation and evaluation program 110A in the client computing device 102 and the cognitive assessment recommendation and evaluation program 110B in the server 112 are stored on one or more of the respective computer-readable tangible storage devices 430 for execution by one or more of the respective processors 420 via one or more of the respective RAMs 422 (which typically include cache memory). In the embodiment illustrated in FIG. 4, each of the computer-readable tangible storage devices 430 is a magnetic disk storage device of an internal hard drive. Alternatively, each of the computer-readable tangible storage devices 430 is a semiconductor storage device such as ROM 424, EPROM, flash memory or any other computer-readable tangible storage device that can store a computer program and digital information.

Each set of internal components 402 a,b also includes an R/W drive or interface 432 to read from and write to one or more portable computer-readable tangible storage devices 438 such as a CD-ROM, DVD, memory stick, magnetic tape, magnetic disk, optical disk or semiconductor storage device. A software program, such as the cognitive assessment recommendation and evaluation program 110A, 110B, can be stored on one or more of the respective portable computer-readable tangible storage devices 438, read via the respective R/W drive or interface 432 and loaded into the respective hard drive 430.

Each set of internal components 402 a,b also includes network adapters or interfaces 436 such as a TCP/IP adapter cards, wireless Wi-Fi interface cards, or 3G or 4G wireless interface cards or other wired or wireless communication links. The software program 108 and the cognitive assessment recommendation and evaluation program 110A in the client computing device 102 and the cognitive assessment recommendation and evaluation program 110B in the server 112 can be downloaded to the client computing device 102 and the server 112 from an external computer via a network (for example, the Internet, a local area network or other, wide area network) and respective network adapters or interfaces 436. From the network adapters or interfaces 436, the software program 108 and the cognitive assessment recommendation and evaluation program 110A in the client computing device 102 and the cognitive assessment recommendation and evaluation program 110B in the server 112 are loaded into the respective hard drive 430. The network may comprise copper wires, optical fibers, wireless transmission, routers, firewalls, switches, gateway computers and/or edge servers.

Each of the sets of external components 404 a,b can include a computer display monitor 444, a keyboard 442, and a computer mouse 434. External components 404 a,b can also include touch screens, virtual keyboards, touch pads, pointing devices, and other human interface devices. Each of the sets of internal components 402 a,b also includes device drivers 440 to interface to computer display monitor 444, keyboard 442, and computer mouse 434. The device drivers 440, R/W drive or interface 432, and network adapter or interface 436 comprise hardware and software (stored in storage device 430 and/or ROM 424).

It is understood in advance that although this disclosure includes a detailed description on cloud computing, implementation of the teachings recited herein is not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is a service oriented with a focus on statelessness, low coupling, modularity, and semantic interoperability. At the heart of cloud computing is an infrastructure comprising a network of interconnected nodes.

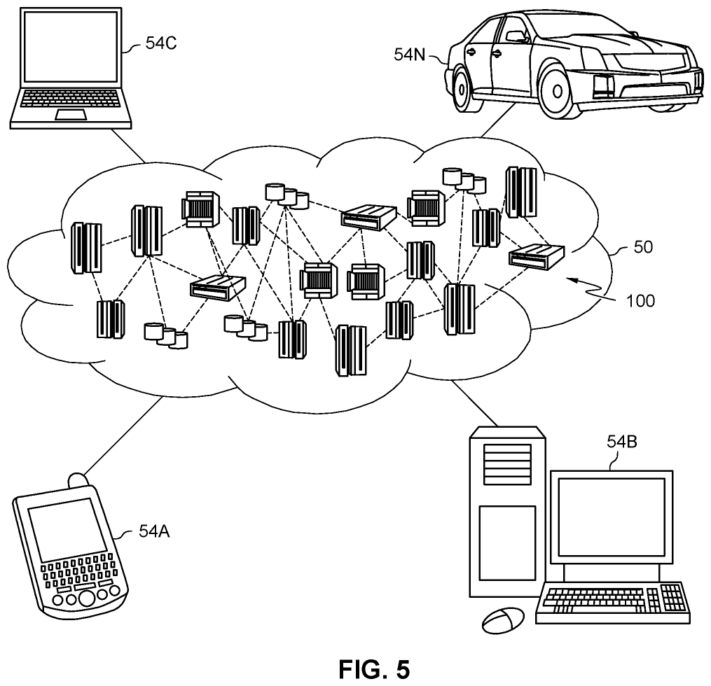

Referring now to FIG. 5, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 100 and cloud computing environment 50 can communicate with any type of computerized device over any type of network and/or network addressable connection (e.g., using a web browser).

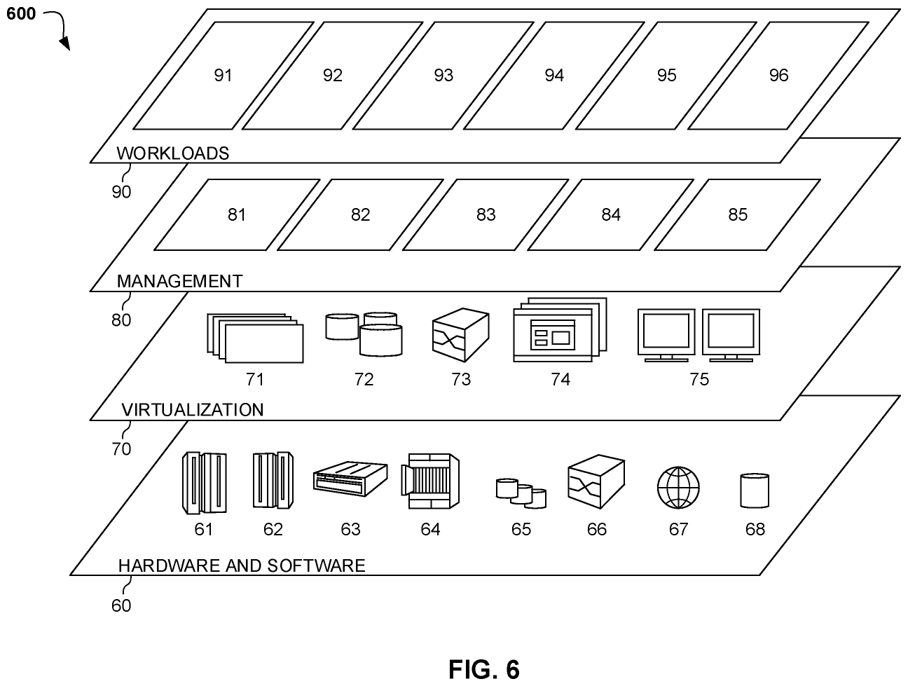

Referring now to FIG. 6, a set of functional abstraction layers 600 provided by cloud computing environment 50 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and cognitive assessment recommendation and evaluation 96. Cognitive assessment recommendation and evaluation 96 may relate to analyzing interview questions and generating referenceable content for later uses, monitoring various databases which may provide information as to developments in job skills, technology, competencies and hiring trends to help determine adequate assessment or interview questions for hiring processes.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for cognitive assessment recommendation and evaluation, the method comprising:
receiving, by a processor, a candidate resume and a job description from a database;
generating interview questions based on common keywords or key phrases found in the candidate resume and the job description;
identifying critical points to be verified based on analysis of candidate responses to the generated interview questions;
validating the critical points against data obtained from public records, official documentation, and documents submitted by the candidate;
creating referenceable content which includes the identified critical points and a summary of the data used to validate the critical points;
determining an evaluation rating for the candidate based on an analysis of how well the qualifications stated in the candidate resumes match job descriptions utilizing pre-configured algorithms; and
storing the referenceable content and the evaluation rating to a database.

2. The method of claim 1, wherein the candidate responses to the interview questions regarding previous similar job positions are analyzed and recorded.

3. The method of claim 1, wherein the database is integrated with a plurality of other systems and databases to receive a continuous feed of newly required job skills, technology, competencies and new hiring trends and generate different versions of current interview questions.

4. The method of claim 1, wherein the database is integrated with information selected from a group consisting of the candidate past accomplishments, experiences, certifications, licenses and published papers.

5. The method of claim 1, further comprising:
collecting the candidate responses during a phone screen process; and
generating a set of auto-fill or pre-populated questionnaires for an in-person interview.

6. The method of claim 1, further comprising:
updating the referenceable content when different responses to the interview questions are provided by new candidates.

7. The method of claim 1, further comprising:
generating a report based on an analysis of candidate's historical responses to similar interview questions and an evaluation of a progress or achieved by the candidate over a certain period of time.

8. A computer system for cognitive assessment recommendation and evaluation, the computer system comprising:
receiving, by a processor, a candidate resume and a job description from a database;
generating interview questions based on common keywords or key phrases found in the candidate resume and the job description;
identifying critical points to be verified based on analysis of candidate responses to the generated interview questions;
validating the critical points against data obtained from public records, official documentation, and documents submitted by the candidate;
creating referenceable content which includes the identified critical points and a summary of the data used to validate the critical points;
determining an evaluation rating for the candidate based on an analysis of how well the qualifications stated in the candidate resumes match job descriptions utilizing pre-configured algorithms; and
storing the referenceable content and the evaluation rating to a database.

9. The computer system of claim 8, wherein the candidate responses to the interview questions regarding previous similar job positions are analyzed and recorded.

10. The computer system of claim 8, wherein the database is integrated with a plurality of other systems and databases to receive a continuous feed of newly required job skills, technology, competencies, and new hiring trends and generate different versions of current interview questions.

11. The computer system of claim 8, wherein the database is integrated with information selected from a group consisting of the candidate past accomplishments, experiences, certifications, licenses, and published papers.

12. The computer system of claim 8, further comprising:
collecting the candidate responses during a phone screen process; and
generating a set of auto-fill or pre-populated questionnaires for an in-person interview.

13. The computer system of claim 8, further comprising:
updating the referenceable content when different responses to the interview questions are provided by new candidates.

14. The computer system of claim 8, further comprising:
generating a report based on an analysis of historical responses of the candidate to similar interview questions and an evaluation of a progress or achieved by the candidate over a certain period of time.

15. A computer program product for cognitive assessment recommendation and evaluation, the computer system comprising:
receiving, by a processor, a candidate resume and a job description from a database;
generating interview questions based on common keywords or key phrases found in the candidate resume and the job description;
identifying critical points to be verified based on analysis of candidate responses to the generated interview questions;
validating the critical points against data obtained from public records, official documentation, and documents submitted by the candidate;
creating referenceable content which includes the identified critical points and a summary of the data used to validate the critical points;
determining an evaluation rating for the candidate based on an analysis of how well the qualifications stated in the candidate resumes match job descriptions utilizing pre-configured algorithms; and
storing the referenceable content and the evaluation rating to a database.

16. The computer program product of claim 15, wherein the candidate responses to the interview questions regarding previous similar job positions are analyzed and recorded.

17. The computer program product of claim 15, wherein the database is integrated with a plurality of other systems and databases to receive a continuous feed of newly required job skills, technology, competencies, and new hiring trends and generate different versions of current interview questions.

18. The computer program product of claim 15, wherein the database is integrated with information selected from a group consisting of the candidate past accomplishments, experiences, certifications, licenses, and published papers.

19. The computer program product of claim 15, further comprising:
collecting the candidate responses during a phone screen process; and
generating a set of auto-fill or pre-populated questionnaires for an in-person interview.

20. The computer program product of claim 15, further comprising:
generating a report based on an analysis of historical responses of the candidate to similar interview questions and an evaluation of a progress or achieved by the candidate over a certain period of time.
